(19) United States
(12) Patent Application Publication
(10) Pub. No.: US 2006/0114695 A1
(43) Pub. Date: Jun. 1, 2006

(54) Bulb holder with an insulator plate for avoiding electric short of the bulb

(75) Inventor: Heng-Lun Tseng, Taipei (TW)

Correspondence Address: BACON & THOMAS, PLLC, 625 SLATERS LANE, FOURTH FLOOR, ALEXANDRIA, VA, 22314, US

(73) Assignee: L&C Lighting Technology Corp., Taipei (TW)

(21) Appl. No.: 11/000,478

(22) Filed: Dec. 1, 2004

(51) Int. Cl. H01R 33/00

(52) U.S. Cl. 362/659

(57) ABSTRACT

A bulb holder for receiving therein a bulb which has two wires extending downward from the bulb has a body and an adapter connected to the body and having two engaging legs extending downward from a bottom of the adapter to the body for electrical connection with the body and two compartments defined in the adapter by an insulator plate which is formed with the adapter for receiving therein a respective one of the two wires of the bulb. The insulator plate is able to avoid undesirable contact between the two wires.

### BACKGROUND OF THE INVENTION

1. Field of the Invention

The present invention relates to a bulb holder, and more particularly to the bulb holder having therein an insulator plate so that an electric short of the bulb is avoided.

2. Description of Related Art

The bulb holder available in the market normally has two extension holes for insertion of two wires extending downward from a bottom face of a bulb for electric connection with a power source. Because the bulb, e.g. a high intensity discharge bulb, and the bulb holder are not integrally formed, the two wires are easily engaged with each other when there is an impact to the bulb holder. That is, movement of the bulb relative to the bulb holder may easily cause the engagement between the two wires such that an electric short occurs, which is very dangerous to the surroundings. However, even though people know that there is a potential danger to both lives and the environment, the design still exists in the market.

To overcome the shortcomings, the present invention tends to provide an improved bulb holder having therein an insulator plate to mitigate the aforementioned problems.

### SUMMARY OF THE INVENTION

The primary objective of the present invention is to provide an improved bulb holder having therein an insulator plate for ensuring separation of the two wires extending downward from the bulb which is received in the bulb holder. Therefore, an electric short is avoided.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the bulb holder of the present invention, wherein a bulb is received in the bulb holder;

FIG. 2 is an exploded perspective view showing the structure of the bulb holder of the present invention; and

FIG. 3 is a schematic view showing the insulator plate is able to keep separate the two wires from the bulb to prevent an electric short.

### DETAILED DESCRIPTION OF THE PREFERRED EMBODIMENT

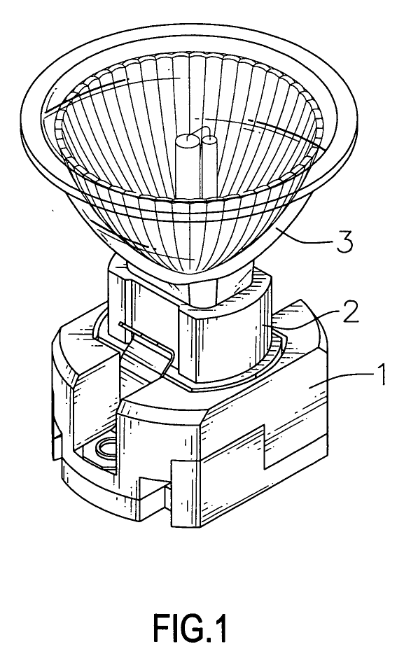

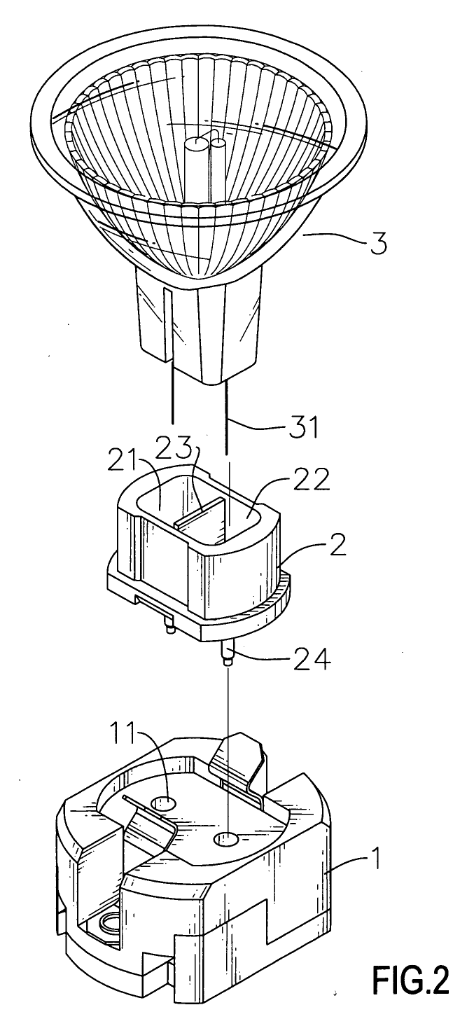

With reference to FIGS. 1 and 2, a bulb holder constructed in accordance with the present invention has a body (1) and an adapter (2) connected to the body (1) and having two compartments (21, 22) defined inside the adapter (2) and divided by an insulator plate (23) which is formed with the adapter (2).

The adapter (2) has two engaging legs (24) extending downward to be inserted into two corresponding holes (11) defined in a face of the body (1) for electric connection with the body (1). Furthermore, a bulb (3) is provided to have two wires (31) extending downward to be respectively received in the two compartments (21, 22) and extended out of the two engaging legs (24).

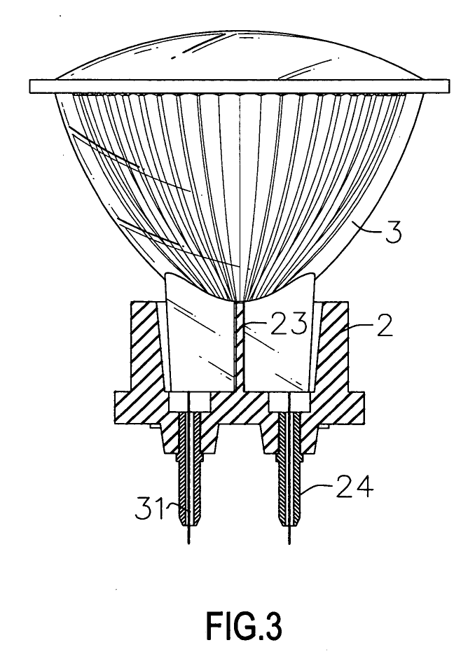

With reference to FIG. 3 in which the body (1) is absent for clarity, it is noted that after the bulb holder of the present invention is assembled the two wires (31) from the bottom of the bulb (3) are extended into and protrude marginally from the engaging legs (24). The insulator plate (23) inside the adapter (2) is able to prevent the two wires (31) from engagement such that the electric short is avoided.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A bulb holder for receiving therein a bulb which has two wires extending downward from the bulb, the bulb holder comprising:
a body; and
an adapter connected to the body and having two engaging legs extending downward from a bottom of the adapter to the body for electrical connection with the body and two compartments defined in the adapter by an insulator plate which is formed with the adapter for receiving therein a respective one of the two wires of the bulb such that the insulator plate is able to avoid engagement between the two wires.
